(19) United States
(12) Patent Application Publication
(10) Pub. No.: US 2013/0097937 A1
(43) Pub. Date: Apr. 25, 2013

(54) Glass Fiber Closure Gasket Terminations

(71) Applicant: Davlyn Manufacturing Company, Inc., Spring City, PA (US)

(72) Inventor: Gary L. FLASHER, Chester Springs, PA (US)

(73) Assignee: Davlyn Manufacturing Company, Inc., Spring City, PA (US)

(21) Appl. No.: 13/653,850

(22) Filed: Oct. 17, 2012

Related U.S. Application Data
(60) Provisional application No. 61/550,672, filed on Oct. 24, 2011.
(60) Provisional application No. 61/555,106, filed on Nov. 3, 2011.
(60) Provisional application No. 61/563,967, filed on Nov. 28, 2011.
(60) Provisional application No. 61/645,967, filed on May 11, 2012.

(51) Int. Cl. E06B 7/22

(52) U.S. Cl. 49/492.1; 49/498.1

(57) ABSTRACT

A flexible, closed loop, closure gasket includes an elongated body having a resiliently flexible wall between opposing ends. The wall is formed by a resiliently flexible, core surrounded by a flexible outer jacket of interwoven glass fiber yarns. The opposing ends are brought together in a permanent joint formed by an permanent fastener-less physical bond between the opposing ends to provide the continuous closed loop. The gasket is typically mounted between a door and a cabinet or other housing of a device subject to modest to moderate heating and/or potential internal fire or explosion, like a home clothes dryer, certain ovens and trash compactors.

### CROSS-REFERENCE TO RELATED APPLICATIONS

This Application claims the benefit of U.S. Provisional Application No. 61/550,672 filed on Oct. 24, 2011; U.S. Provisional Application 61/555,106 filed on Nov. 3, 2011; U.S. Provisional Application 61/563,967 filed on Nov. 28, 2011 and U.S. Provisional Application 61/645,967 filed on May 11, 2012, all incorporated by reference herein in their entireties.

### BACKGROUND OF THE INVENTION

The present invention relates to glass fiber closure gaskets widely used in ovens and having other uses.

Oven gaskets are provided to close the gap that exists between the door and cabinet of an oven to retain heat in the oven. Oven gaskets usually have an outer surface of tightly interwoven yarns of glass fiber to withstand the heat of the oven. Typical oven gasket bodies are most efficiently made in continuous lengths, for example, by braiding glass fiber yarns around a resilient core such as a tube of interwoven spring wires, cut to a particular length for use, and the ends of the cut length brought together in a termination. Most previous known oven gasket terminations have been mechanical using fasteners such as staples or mounting clips or otherwise using a relatively short metal panel clamped over the ends. Recently U.S. Pat. No. 7,735,836 issued describing a termination in which the ends of a gasket body were telescoped together and held in compression by nearby clips used to mount the gasket to the oven cabinet or door. Oven manufactures are always looking to improve the appearance of the products while maintaining high levels of performance.

There are certain other home appliances in which gaskets used to close a door opening or panel opening or gap might be subject to sudden fire or even explosion under certain adverse conditions. For example, clothes dryers normally operate by generating relatively modest levels of heat (less than 90° Centigrade and, more typically, only about 65° Centigrade) but are also subject to possible fire from the ignition of clothes being dried or built-up lint in the cabinet or the presence of volatile residue in the clothes being dried.

The closure gasket surrounding a clothes dryer door is usually a polymer extrusion, such as EPDM or another synthetic rubber or flexible plastic. Such gaskets are designed to cope only with the extremes of the normal modest operating temperatures of such dryers. Unlike a domestic kitchen oven, where the door gasket is exposed to relatively moderate temperatures of hundreds of degrees Centigrade, the gaskets of domestic clothes dryer doors are typically subject to generally modest operating temperatures, which can be safely sustained by at least some polymer materials. However, where fires begin in such appliances, the polymer gasket can melt and permit a greater flow of air into the appliance to feed the fire. In worst cases, the gasket can actually ignite, contributing fuel to the fire and toxic fumes.

Another home appliance that does not ordinarily generate heat in operation is the trash compactor. However, trash compactors are subject to fire from the spontaneous combustion of compressed garbage and even explosion from the puncture of a pressurized container holding combustible gases.

While reference has been made above to home or domestic appliances, there are corresponding industrial and commercial ovens, dryers, trash compactors and other devices which have ordinarily used polymer gaskets but have similar gasket needs for similar operating temperatures and/or danger of possible fire or explosion

It is desirable for the gaskets of all such devices to remain functional with a fire to inhibit the flow of air past the gasket. It would be desirable to provide a competitively priced, flexible closure gasket safer than a polymer gasket for use in domestic clothes dryers, trash compactors, at least ordinary ovens as well as at least some corresponding commercial or industrial devices, and any other gasketed structures that are subject to moderate levels or heat for operation or might otherwise be subject to the danger of fire or explosion.

### SUMMARY OF THE INVENTION

A flexible, closed loop, closure gasket including an elongated body having first and second opposing ends, the elongated body member having a resiliently flexible wall formed by a resiliently flexible core surrounded by a flexible outer jacket of interwoven glass fiber yarns, characterized by the first and second opposing ends of the elongated body member being brought together and held in a permanent joint by a fastener-less physical bond between the opposing ends to form a continuous closed loop closure gasket.

### BRIEF DESCRIPTION OF THE DRAWINGS

The foregoing summary, as well as the following detailed description of preferred embodiments of the invention will be better understood when read in conjunction with the appended drawings. In the drawings:

FIG. 1 is a perspective, diagrammatic, partially broken away view of a portion of a length of an elongated body member of a currently preferred glass fiber and metal wire construction used to form the body of a closed loop, glass fiber closure gasket of the invention;

FIG. 2 is a diagrammatic transverse section view of part of the length of material of FIG. 1 showing a preferred construction to provide optional mounting fasteners in the form of wire spring clips;

FIG. 3 is a side elevation of an exemplary spring wire clip;

FIG. 4 is a bottom plan view of the exemplary spring wire clip of FIG. 3;

FIG. 5 depicts diagrammatically opposing male and female ends of a length of a tubular, elongated body member before joining to form a closed loop gasket;

FIG. 6 depicts diagrammatically the male end inserted within the female end of the tubular material to form a continuous, closed loop gasket;

FIG. 6A depicts diagrammatic cross sectional view taken along the lines A-A in FIG. 6 of the joint formed by the male and female telescoped ends;

FIG. 7 depicts diagrammatically, the mounting of a closed loop tubular gasket of the present invention to an appliance door.

FIG. 8 depicts diagrammatically opposing cut ends of a length of the tubular glass fiber/metal wire material before treatment to form another version of a closed loop gasket;

FIG. 9 depicts diagrammatically treatment of the opposing ends of the length of the tubular glass fiber/metal wire material of FIG. 8 before joining the ends to form a closed loop gasket;

FIG. 10 depicts diagrammatically the joint formed by joining together the treated ends of the tubular glass fiber/metal wire material;

FIG. 11 is a diagrammatic perspective view of revision of the gasket construction of the first embodiment of FIGS. 5-6; and

FIG. 12 is a diagrammatic perspective view of revision of the gasket construction of the second embodiment of FIGS. 8-10.

### DETAILED DESCRIPTION OF THE PREFERRED EMBODIMENTS

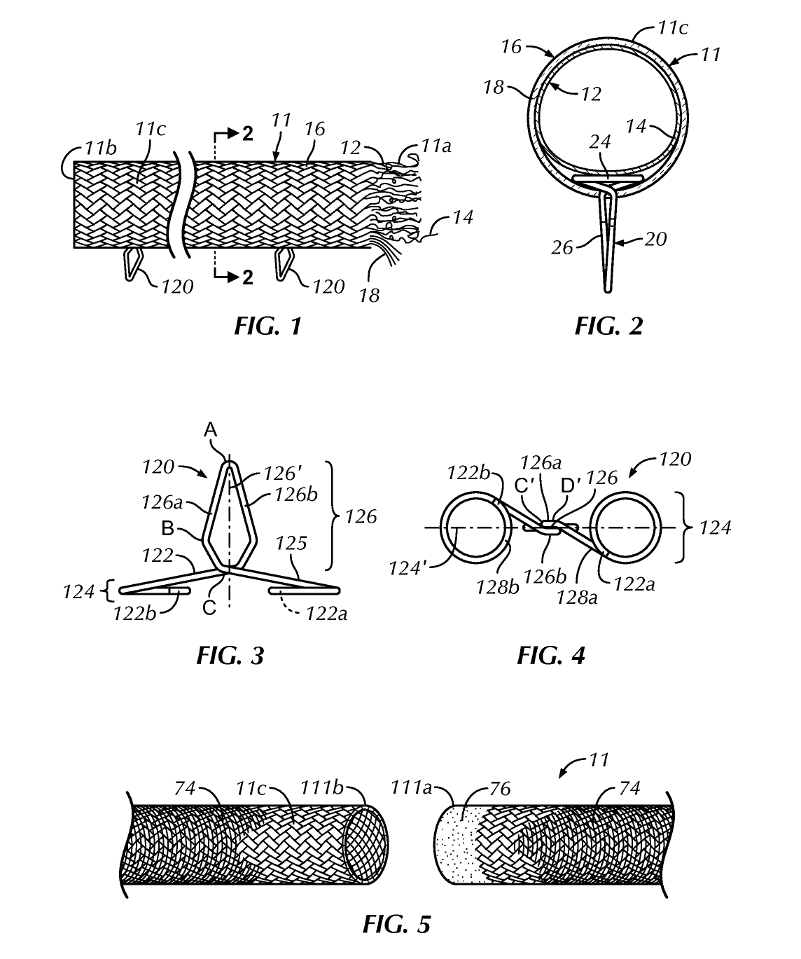

In the drawings, like numerals indicate like elements throughout. FIGS. 1-2 depict a partial length of a preferred embodiment elongated body 11 used to form a flexible, closed loop closure gasket 10 of the present invention. Elongated body 11 has first and second opposing ends 11a, 11b and a resiliently flexible wall 11c between the ends 11 a, 1 lb. The wall 11c is preferably formed by an elongated, resiliently flexible core 12 surrounded by an elongaged, flexible outer jacket 16 of interwoven glass fiber yarns 18. The outer jacket 16 is not as resilient as the core 12.

Preferably, the elongated body 11 is tubular, continuous and seamless as are the core 12 and outer jacket 16. More particularly, the core 12 is preferably a continuous, seamless, resiliently flexible, tubular member with a continuously closed, normally circular, transverse cross sectional shape seen in various figures, formed from a plurality of metal spring wires 14 of stainless steel or other at least partially hardened metal for resilience, preferably knitted but possibly braided or woven together in a conventional fashion. The core 12 has been extended from one end 11a of the jacket 16, which has itself been frayed in FIG. 1 only for clarity. Normally, both ends 11a and 11b are cut without frays like end 11b in FIG. 1 and square to the central longitudinal axis of the elongated body 11.

The outer jacket 16 is also preferably a continuous, elongated, seamless, flexible tubular member of normally circular cross sectional shape that closely surrounds and extends along the core 12. The glass fiber yarns 18 of the outer jacket 16 are preferably braided together for tightness of the weave but may be knitted together or otherwise interwoven together. The elongated core 12 is preferably but not necessarily at least as heat sustaining as the outer jacket 16, one of the reasons why metal wire is preferred. However, as will be seen, it is possible to form the elongated core 12 from glass fiber, such as a solid rope of glass fiber yarns or a transversely uniform metal wire mesh or a combination of glass fiber and metal wire. Depending upon the end use, the core 12 might be made of other materials including polymer rope or mesh as the core 12 will be protected to some extent from direct heat exposure by the glass fiber outer jacket 16.

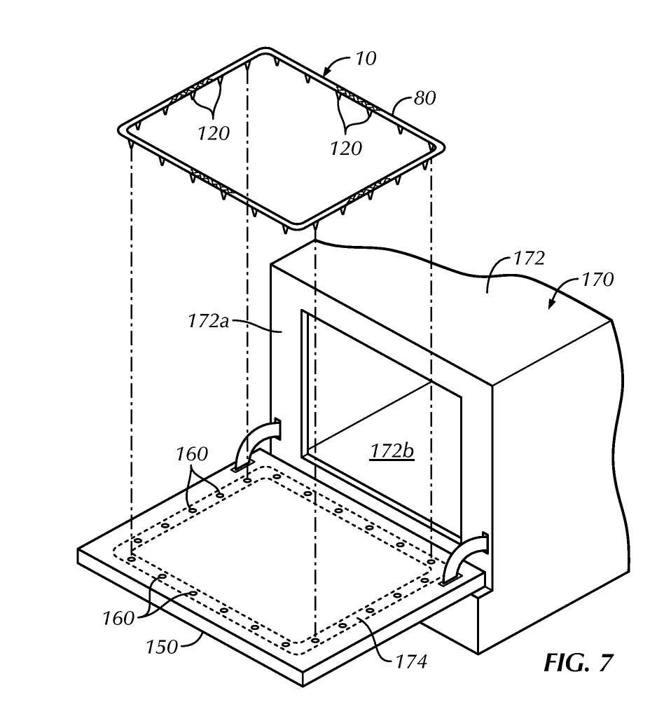

If desired, the elongated body 11 and resulting closure gasket 10 may be provided with a plurality of mounting fasteners. If mounting fasteners are provided, they are preferably separate, individual wire spring clips and are preferably spaced at predetermined intervals along the length of the elongated body 11 forming the gasket 10, like clips 120 in FIGS. 1 and 2. One such preferred spring wire clip 120 is shown separately in FIGS. 3 and 4. As can be seen in the figures, the preferred spring clip 120 is made from a single length of at least partially hardened metal wire 122 bent to define a generally planar base portion or “base” 124 and a generally planar, generally diamond-shaped engagement portion or dart 126 projecting transversely from one major planar side 125 of the base 124. The dart or engagement portion 126 is formed by bending the wire at three places (A, B, C) to form a pair of opposing, resiliently flexible and flexibly joined side portions or “sides” or “arms” 126a, 126b. Arms 126a, 126b can be compressed together to pass through an opening 160 in a support member to which the finished gasket 10 is attached (FIG. 7). The free portions of the wire 122 are bent at C′ (FIG. 3) and are extend past one another, side by side. The remaining free end portions of the wire 122 are bent again (at D′ in FIG. 4) generally in a plane perpendicular to the dart 126 to partially wrap about one another and to extend away from the dart 126 in opposing directions. The base 124 is completed by curling the remaining free end portions of the wire 122 into separate loop portions 128a, 128b. Preferably, the first portion 128a is a reversed mirror image of the second portion 128b of the base 124 on opposing lateral sides of the central longitudinal axis 126′ of dart 126 when the base 124 is viewed in plan. The base 124 of the wire spring clip is located inside the elongated body 11 and the engagement portion 126 extends transversely to the base 124 through at least the outer jacket 16 of the flexible wall 11c so as to protrude from the elongated body member 11 spaced at predetermined intervals along the flexible wall 11c. As is best seen in FIG. 2, preferably the base 124 of each wire spring clip 120 is captured between the core 12 and the outer jacket 16 with the engagement portion 126 extending transversely away from the base 124 and protruding outwardly through the outer jacket 16 between the yarns 18. Alternatively, the engagement end 126 of the clips 120 can be passed entirely through the flexible wall 11c from inside the tubular core 12. Other known alternative configurations include the provision of individual spring wire clips with circular or spiral bases that can be twisted into and through the tubular wall 11c and strings of connected clips formed by a continuous piece of wire, bent at several spaced locations to form a string of clips in place of separate, individual clips. Still other types of spring metal clips with other geometries are known and can be used as mounting fasteners.

According to one aspect of this invention, a polymer coating 74 preferably is provided on the exposed surface of the outer jacket 16 covering at least the exposed outer surfaces of the individual interwoven glass fiber yarns 18 of the outer jacket 16 at least at the opposing ends 11a, 11b of the elongated body 11. More preferably, the polymer coating 74 also covers the exposed outer surfaces of the interwoven glass fiber yarns 18 of the outer jacket 16 along the entire length of the flexible wall 11c between the opposing ends 11a, 11b. The polymer coating 74 is preferably the solid residue of a polymer resin emulsion applied to the glass fiber yarns 18 forming the outer surface of the elongated body 11. The polymer coating 74 is indicated diagrammatically by shading on portions of the tubular wall 11 in FIGS. 5, 6 and 9-12. The polymer coating 74 covers at least essentially all of an outer surface of each yarn 18 to the extent that surface is exposed on the outer jacket 14 of the gasket 10 and will penetrate into the yarn but may not penetrate completely into or through a yarn 18. Such acrylic resin emulsions are commercially available as binders.

The outer jacket 14 is coated with the flexible polymer material, preferably in the form of a flexible polymer resin coating 74 applied as a water based emulsion containing polymer resin solids. The emulsion may be formed using conventional equipment normally used for preparing latex coatings and paints and may be applied to the outer surface of continuous lengths of the elongated body 11 in an appropriate manner for such emulsions such as spraying, brushing, rolling and/or immersion. Polymer resins available for such use include acrylics, vinyls and silicones. It is suggested that the concentration of polymer resin solids be less than ten percent and preferably only about five percent or less of the emulsion. Also, the coating 74 can be colored in a shade from gray to black by adding graphite to the emulsion.

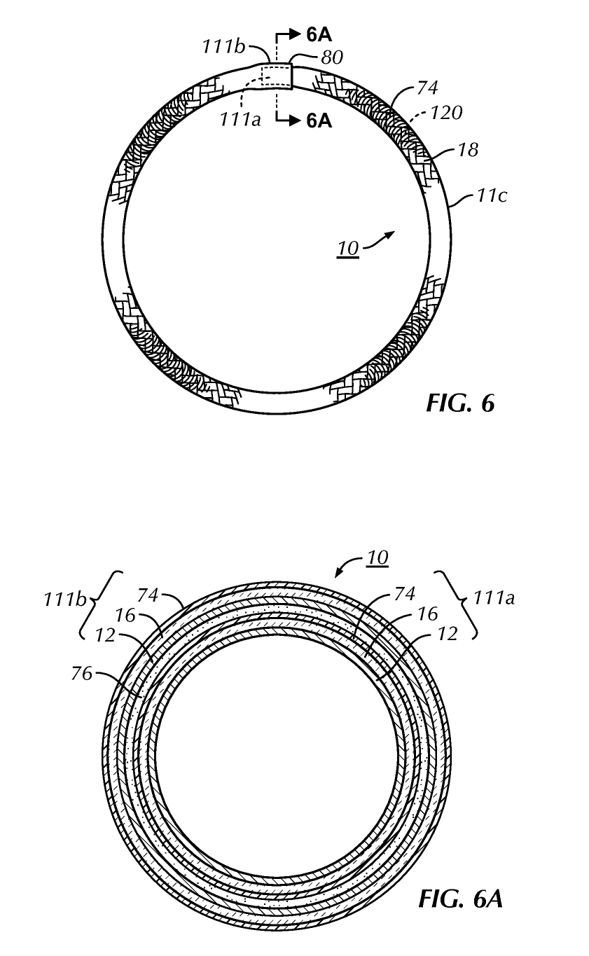

After application, the liquid portion of the emulsion on the outer jacket is driven off, suggestedly by drying at a maximum temperature below that at which the polymer resin would burn off the elongated body. More preferably, the polymer resin coating 74 may be dried at room temperature to the point where the polymer resin coating does not rub off by ordinary handling. The polymer resin coating 74 may partially or completely dried by passage through an oven at temperatures up to about 150° C. (300° F.) for faster drying and/or to cause cross-linkage of the polymers. The resin of coating 74 tends to soak into the yarns 18 rather than form a distinct layer. Distinct layers are shown in FIG. 6A only for illustration. A coating 74 is provided in this way in an amount which is insufficient to obscure the individual yarns 18 of the outer jacket 16 from one another, thus allowing the observer to still identify the individual yarns in the braid or other weave and even the fibers of the yarns. The coating 74 is also sufficiently flexible to flex with the closure gasket 10 during use. The coating 74 also improves abrasion resistance of the surface of the yarns 18.

FIGS. 5-6 depict a first method of construction and flexible, closed loop, closure gasket 10 according to the present invention. An individual elongated body 11 (FIG. 5) of appropriate length is preferably cut from a longer, continuous length of outer jacket glass fiber yarns 18 interwoven over a more resilient elongated core 12 (not depicted) to fabricate an individual gasket 10. In FIG. 5, opposing first and second cut ends 11a, 11b (FIG. 1) are configured as a male end 111a and a female end 111b, respectively, to be telescoped together with the first/male end 11a inserted into and secured with the second/female end 11b to form a permanent joint 80 (FIG. 6). The male end 111a can be formed by jamming a first end 11a into an appropriately sized funnel fixture to taper radially inwardly (i.e. collapse) the first end 11a into a reduced tapered diameter. Alternatively or in addition, the female end 111b can be form by jamming the second end 11b onto a conical tool to radially outwardly taper (i.e. expand) the second end 11b. The thickness of the tubular wall 11c with the described materials is only about 0.5 mm. The wires 14 and glass yarns 18 at the cut ends 11a, 1 lb of the elongated body 11 are sufficiently flexible and free from constraint as to permit such inward and outward tapering and the ends will remain compressed and expanded to be telescoped together.

The joint 80 is made permanent by providing a fastener-less permanent bond, in this case, preferably an adhesive bond between the joined opposing first and second ends 11a, 11b. A permanent adhesive bond may be formed by a layer of an adhesive, cement, resin, glue or other like material that bonds mechanically and/or chemically by drying or curing with the polymer resin coating or any exposed glass fiber yarns 18 on the end 111 a and the wire 14 or inner surface of the glass fiber yarns 18 that might be exposed inside the female end 111b. Preferably, a layer of a suitable adhesive material 76, such as an acrylic based adhesive, compatible with an acrylic polymer coating 74, is applied to the outer surface of the first male end 111a and/or the inner surface of the second female end 111b before the ends 111a, 111b are telescoped together. After telescoping the ends 111a, 111b together, the joint 80 can be compressed by hand to reduce the diameter of the joint and to smooth the outer surface of the gasket 10 at the joint 80. FIG. 6A depicts diagrammatically the three layers of each end 111a, 111b and the adhesive layer 76 therebetween at joint 80. After drying or curing, the adhesive material 76 forms a permanent adhesive bond between and directly with opposing ends 111a, 111b to form the continuous, closed loop closure gasket 10 depicted in FIG. 7 with a barely discernable permanent joint 80. An alternative adhesive is a liquid silicone rubber subsequently identified. Silicone has the advantage of a much higher temperature tolerance (in the range 400-500° C.) than other polymers.

The flexible, closed loop, closure gaskets of the present invention are installed in any suitable device subject to any of heated operation and/or potential internal fire or explosion. FIG. 7 depicts diagrammatically a gasket 10 of the present invention mounted to a door 150 or the opposing cabinet or other housing 172 of a generic device 170. While the gasket 10 is depicted as being mounted to the door 150 of the device 170, it might be mounted to the housing 172 of the device 170 on the surface 172a of the housing 172 surrounding the housing opening 172b facing the door 150 to close a gap between the door 150 and the housing 172 with the door closed against the housing. The device 170 can be a home clothes dryer or even a type home cook oven having sufficiently low maximum operating temperature, which would include at least conventional (non-pyrolytic/non-self-cleaning) home cooking ovens, and even some pyrolitic home cooking ovens. Similarly gaskets could be installed in place of polymer gaskets in the doors or lids of home trash compactors.

The flexible, closed loop, closure gasket 10 may be mounted directly to the door 150 (or the housing 172) of the device 170 by another adhesive layer 174 between the device 170 and the gasket 10. Adhesive layer 174 is indicated by shading between broken lines in FIG. 7. An appropriate adhesive such as an H. B. Fuller FX-4232-E acrylic adhesive currently used to adhere EPDM gaskets to the doors of such home clothes dryers might be used. Alternatively, spring clips 120 may provided, with the exposed engagement portion of each clip 120 mating with a corresponding hole 160 or other mating engagement position provided in the door 150 (or face 172a of the housing 170) to be the sole attachment between the gasket 10 and appliance 170 or other device. Another alternative mounting is the use of a combination of spring clips 120 and an adhesive layer 174 as indicated.

The outer jacket 16 with polymer coating 74 cuts off essentially all flow of moist hot air generated by the normal operation of a home clothes dryer and even a non-pyrolitic home oven. In the event of fire, no more than the portion of the polymer resin exposed to direct heat of the fire in the appliance housing might be melted or burned away while the remainder of the coating, either in direct contact with the housing or door or in the gap between them facing away from the housing opening covered by the door, should remain intact or essentially intact to continue to seal or at least essentially seal the door opening and preventing air flow to a fire in the appliance housing. Even if all of the polymer resin were to melt or ignite, the amount of polymer resin being applied is almost negligible so its contribution to any fire would also be negligible. Moreover, the outer jacket 16 can be provided with a sufficiently tight braid of yarns 18 to retard the flow of gas without the benefit of a full polymer coating at relatively low pressure differentials as might be caused by the normal operation of a clothes dryer or oven or even a small fire.

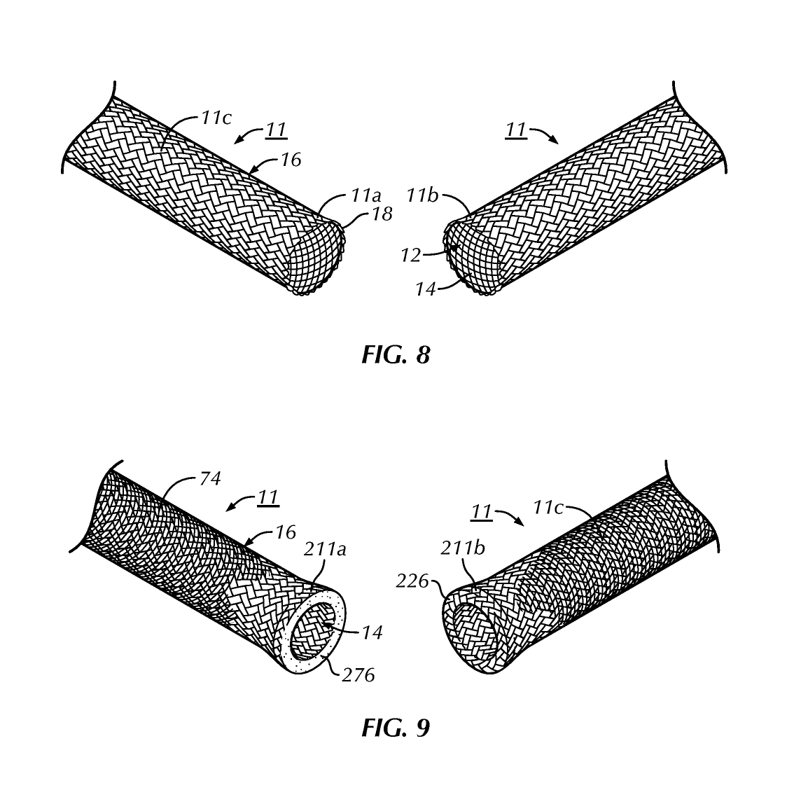

FIGS. 8-10 depict another method of fabrication of another version of a closed loop, closure gasket 210 of the present invention. As indicated in FIG. 8, an elongated body 11 of a substantially final desired length of the circumference of a closed loop closure gasket 210 is cut from the previously described, continuous lengths of preferred glass fiber/metal wire tubular material, with or without a polymer resin coating. As indicated in FIG. 8, the ends 211a, 211b after cutting are fairly integral without fraying of the glass fibers 18 or metal wires 14. Referring to FIG. 9, free ends of the interwoven glass fiber yarns 18 of the outer jacket 16 at the opposing ends 211a, 211b of the elongated body 211 are preferably turned inward over the proximal free ends of the interwoven wires 14 of the core 12 to cover the free ends of the interwoven wires 14 and core 12. This can be done by pushing the ends of the core 12 back into the ends of the outer jacket 16, by stretching the ends of the outer jacket 16 out over the ends of the core 12 or by a combination of both actions. The knit of the resilient metal wires 14 of the core 12 should tend to retract into the ends of the outer jacket 16 while the braid of the outer jacket 16 permits the ends of the outer jacket 16 to be elongated while tapering down slightly. Only enough of the ends of the glass fiber yarns 18 need to be extended from the ends of the wires 14 of the core 12 ends to permit the glass fiber yarn ends to be folded back over the wire ends into the interior of the core 12 of elongated body 11 to cover the wire ends of the core 12 and form free ends of glass fiber now indicated as 211a, 211b.

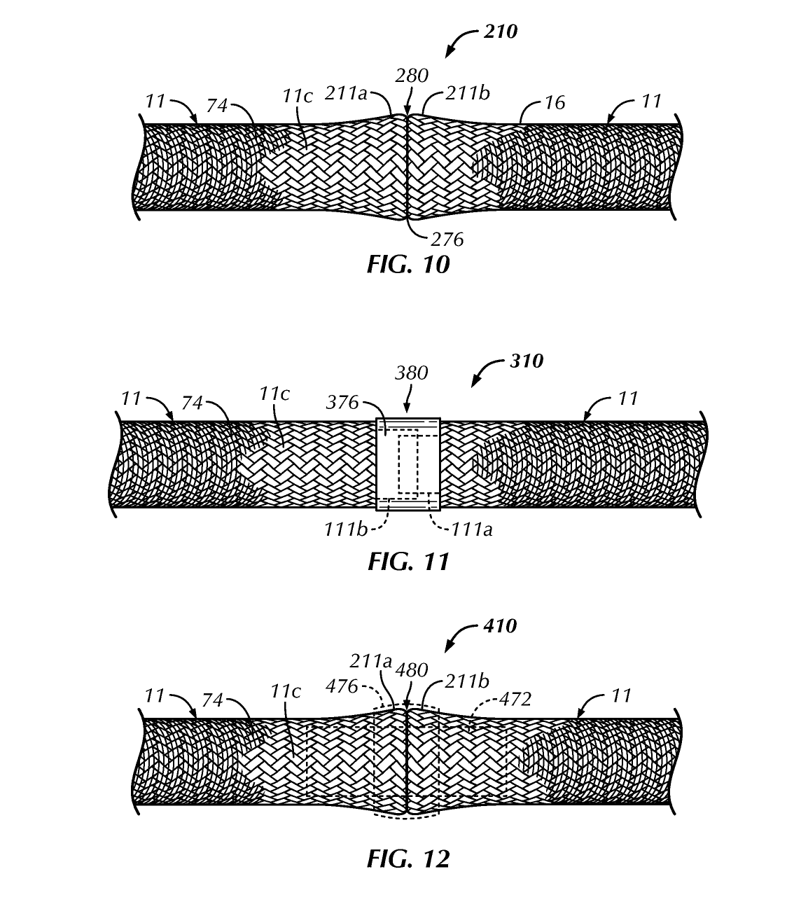

A layer 276 of an appropriate heat resistant adhesive such as the previously identified acrylic adhesive or any other adhesive compatible with the glass fiber yarns 18, such as the cement used by manufacturers to adhere clothes dryer polymer closure gaskets to dryer doors, or any polymer resin coating, if such coating is provided on the exterior of the elongated body 211, is applied to the butt ends 211a, 211b. The ends 211a, 211b are brought together as shown in FIG. 10 and the adhesive cured to form a permanent bond between the ends 211a, 211b and a closed loop closure gasket 210 with a barely visible, permanent, adhesive joint 280 between the butted glass fiber ends 211a, 211b.

The outer jacket 216 is preferably coated with a polymer resin layer 74 as previously described. Alternatively, it can be provided over just part of the surface, for example, just the ends 211a, 211b or just the inner or outer circumferential surface of the final closed loop gasket or over none of the surface. A polymer resin coating is not required to make the joint 280 permanent. The adhesive may be applied directly to and bond directly with the glass fibers 18 at one or both ends 211a, 211b of the elongated body 211 to adhere the ends 211a, 211b together.

FIG. 11 depicts another method of fabrication and a resulting closed loop closure gasket embodiment of the invention indicated generally at 310. This is a variation on the gasket embodiment 10 of the first set of FIGS. 5-6 with a different permanent joint 380. Again, an elongated body 11 of an appropriate length, with or without a polymer resin coating 74, is cut from longer, continuous length of tubular material. As in FIG. 5, first and second opposing free ends, preferably a male end 111a and a female end 11 lb of the elongated body 11 are telescoped together to form a joint. Preferably, a layer of a suitably compatible adhesive 376, such as a silicone rubber, is then applied to the outer surface of the telescoped ends 111a, 111b of the elongated body 11 at the joint 380 and allowed to cure over the telescoped ends to provide a permanent adhesive bond in the form of a polymer layer band 376 over the telescoped ends and form a continuous, closed loop closure gasket 310 similar to gasket 10 in FIG. 7, again with a barely discernable joint 380. The depicted layer 376 may be provided by a two part Dow Corning 95-590 liquid silicone rubber, which was applied around the junction of the ends 10a, 10b, covered with a two part tubular mold and compressed into the smooth tubular form showed. The layer 376 was then allowed a sufficient length of time to cure before the mold was removed.

FIG. 12 is a perspective view of the joint area of another version of a continuous, closed loop, closure gasket of the present invention indicated generally at 410 that is a modification of the gasket construction of FIGS. 8-10. However, this construction might also be used in a modified version of the embodiment of FIG. 11. As was indicated in FIG. 8, an elongated body 11 of a desired final gasket length, with or without a polymer resin coating 74, is again cut from a longer, continuous length of the previously described, glass fiber/metal wire tubular material. Again, the opposing ends 211a, 211b after cutting are fairly integral without fraying of the glass fibers 18 or metal wires 14 and are butted together. The free ends of the outer jacket glass fibers 18 may again be turned inward over the proximal free ends of the tubular core metal wires 14 forming glass butt ends 211a′, 211b′. However, that is not a requirement. Next, a tubular reinforcement member 472, such as a relatively short length of a plastic tube like a thick walled silicone or other polymer having a sufficiently high glass transition temperature to withstand the proposed working temperatures of the gasket 410, is jammed into each of the butted together opposing ends 211a, 211b of the elongated body 11. Tubular reinforcement member 472 is indicated in phantom in FIG. 12 within the gasket 410 spanning joint 480. A layer of an adhesive material can be applied to an outer surface of the reinforcement member 472 and/or the cut ends 211a, 211b or glass but ends glass fiber ends 211a′, 211b′ on the inside of each of those opposing ends to form a permanent joint between the opposing ends 211a, 211b and the reinforcement member 472. Alternatively, the adhesive may be applied to the end faces of the opposing ends 211a, 211b (like the embodiment of FIGS. 8-10) securing the end faces of the ends 211a, 211b directly together, or some combination of both types of bonds. Alternatively or in addition, a layer 476 (also phantom in FIG. 12) of a suitably compatible polymer adhesive, such as the previously identified liquid silicone rubber, can be applied over the brought together opposing ends 211a, 211b of the elongated body 11 and the tubular reinforcement member 472 within the ends 211a, 211b to adhere the ends 211a, 211b together and complete the joint 480.

While the gasket embodiments described thus far utilized what might be generically referred to as an adhesive bond, the provision of a layer or coating of a material that remains between the gasket ends to form a discernable but fastener-less physical bond, other types of fastener-less physical bonds can be created without a discernable other material by other means such as solvents or the application of heat to directly fuse together the polymer coatings on the brought together ends of an elongated body member.

While gaskets of the present invention have been described for use in home appliance doors, they may find application elsewhere. For example, gaskets of the present invention might be used at the door openings of trash chutes found in multistory apartment buildings. While home use is particularly described, it will be appreciated that the gaskets of the present invention could be used in comparable commercial and industrial applications including dryer, ovens and other heaters as well as compactors. The gaskets may be used to otherwise seal other types of door, lid or panel openings around enclosed spaces subject to moderate heat or unintended fire or explosion.

I claim:

1. A flexible, closed loop, closure gasket including an elongated body having first and second opposing ends, the elongated body member having a resiliently flexible wall formed by a resiliently flexible core surrounded by a flexible outer jacket of interwoven glass fiber yarns, characterized by the first and second opposing ends of the elongated body being brought together and held in a permanent joint by an adhesive bond between the opposing ends to form a continuous closed loop closure gasket.

2. The flexible, closed loop, closure gasket of claim 1 wherein the fastener-less physical bond is an adhesive bond.

3. The flexible, closed loop, closure gasket of claim 1 wherein the resiliently flexible core is hollow and wherein the first and second opposing ends are telescoped together to form the permanent joint.

4. The flexible, closed loop, closure gasket of claim 1 wherein the first and second opposing ends of the elongated body are butted together to form the permanent joint.

5. The flexible, closed loop, closure gasket of claim 4 wherein the resiliently flexible core is hollow and wherein free ends of the interwoven glass fiber yarns at the opposing ends of the elongated body are turned inward over proximal free ends of the flexible core to cover the free ends of the flexible core and the turned ends of the interwoven glass fiber yarns are butted and bonded to one another to form the permanent joint.

6. The flexible, closed loop, closure gasket of claim 5 further comprising a tubular reinforcement member jammed into each of the butted together opposing ends of the elongated body.

7. The flexible, closed loop, closure gasket of claim 1 where the permanent joint includes a polymer material band formed around outer surfaces of the brought together ends and bonding to each of the opposing ends to hold the opposing ends together in the joint.

8. The flexible, closed loop, closure gasket of claim 1 wherein a polymer coating covers at least the exposed outer surfaces of the interwoven glass fiber yarns of the outer jacket at least at the opposing ends of the elongated body before the joint is formed.

9. The flexible, closed loop, closure gasket of claim 8 wherein the polymer coating also covers the exposed outer surfaces of the interwoven glass fiber yarns of the outer jacket along the length of the flexible wall between the opposing ends.

10. The flexible, closed loop, closure gasket of claim 1 wherein the core is at least as heat sustaining as the outer jacket.

11. The flexible, closed loop, closure gasket of claim 10 wherein the core is formed from glass fiber, metal wire or a combination of glass fiber and metal wire.

12. The flexible, closed loop, closure gasket of claim 1 wherein the polymer resin of the coating includes acrylic polymer resin and the bond is formed by an acrylic based adhesive.

13. The flexible, closed loop, closure gasket of claim 1 wherein the polymer resin coating includes silicone and the bond is formed by an silicone based adhesive.

14. The flexible, closed loop, closure gasket of claim 1 further comprising a plurality of mounting fasteners each protruding from the flexible outer jacket of the elongated body spaced at predetermined intervals along the flexible wall.

15. The flexible, closed loop, closure gasket of claim 14 wherein each of the plurality of mounting fasteners is an individual wire spring clip having a base portion located inside the elongated body and an engagement portion extending transversely to the base portion through at least the outer jacket of the flexible wall so as to protrude from the elongated body spaced at predetermined intervals along the flexible wall.

16. The flexible, closed loop, closure gasket of claim 1 installed in a device subject to any of heated operation, internal fire or explosion, the gasket being mounted to a door of the device or a housing of the device facing the door of the device to close a gap between the door and the housing.

17. The flexible, closed loop, closure gasket of claim 16 mounted to the door of the device or a surface of the housing of the device facing the door at least in part by an adhesive layer between the device and the glass fiber outer jacket of the gasket.

18. The flexible, closed loop, closure gasket of claim 17 mounted to the door of the device or the cabinet of the device facing the door exclusively by the adhesive layer between the device and the glass fiber outer jacket of the gasket.

19. The flexible, closed loop, closure gasket of claim 1 wherein the device is one of a dryer, an oven and a trash compactor.
